(19) United States
(12) Patent Application Publication
(10) Pub. No.: US 2020/0131381 A1
(43) Pub. Date: Apr. 30, 2020

(54) RADIATION CURABLE INK COMPOSITION AND RECORDING METHOD

(71) Applicant: Seiko Epson Corporation, Tokyo (JP)

(72) Inventors: Naoki KOIKE, Matsumoto (JP); Toru SAITO, Yamagata (JP); Toshiyuki YODA, Matsumoto (JP)

(21) Appl. No.: 16/668,120

(22) Filed: Oct. 30, 2019

(30) Foreign Application Priority Data
Oct. 31, 2018 (JP) 2018-204588

(51) Int. Cl. C09D 11/101; C09D 11/107; C09D 11/30; B41J 11/00; B41M 5/00

(52) U.S. Cl. CPC C09D 11/101; C09D 11/107; B41M 5/0023; B41J 11/002; C09D 11/30

(57) ABSTRACT

A radiation curable ink composition includes 5 to 30 mass % of a monofunctional urethane (meth)acrylate and 5 to 30 mass % of a nitrogen-containing monofunctional monomer having a cyclic skeleton containing a nitrogen atom.

The present application is based on, and claims priority from, JP Application Serial Number 2018-204588, filed Oct. 31, 2018, the disclosure of which is hereby incorporated by reference herein in its entirety.

### BACKGROUND

### 1. Technical Field

The present disclosure relates to a radiation curable ink composition and a recording method.

### 2. Related Art

Ink jet recording methods can record high-resolution images with relatively simple apparatuses and have been rapidly developed in various fields. Among them, for example, discharging stability has been variously studied. For example, JP-A-2012-007107 discloses an ink composition containing a photopolymerizable compound and a photopolymerization initiator, wherein the photopolymerizable compound contains a photopolymerizable monomer having one ethylenic unsaturated double bond and at least one urethane bond, and the content of the photopolymerizable monomer is adjusted such that 1 g of the photopolymerizable compound contains 2.8 to 4.7 mmol of urethane bonds, in order to provide a photocurable ink jet printing ink composition that has excellent photocurability and, even if a base material is thermoformed, can form a cured coating film having good drawability, heat resistance, and punching workability.

However, it has been found that if an ink contains a photopolymerizable monomer having one ethylenic unsaturated double bond and at least one urethane bond in an amount such that the amount of the urethane bond is 2.8 to 4.7 mmol for 1 g of the photopolymerizable compound (in weight conversion, for example, 69 wt % in an ink), as in the invention described in JP-A-2012-007107, problems of increasing the initial viscosity of the ink and decreasing the storability of the ink are caused. Such an increase in viscosity and a decrease in storability may also damage the discharging stability of ink jet heads.

### SUMMARY

The present inventors have diligently studied to solve the above-described problems. As a result, it has been found that the problems can be solved by using a predetermined amount of a monofunctional urethane (meth)acrylate and a predetermined amount of a nitrogen-containing monofunctional monomer having a cyclic skeleton containing a nitrogen atom in combination, and the present disclosure has been accomplished.

That is, the present disclosure is as follows.

1. A radiation curable ink composition including 5 to 30 mass % of a monofunctional urethane (meth)acrylate and 5 to 30 mass % of a nitrogen-containing monofunctional monomer having a cyclic skeleton containing a nitrogen atom.

2. The radiation curable ink composition according to aspect 1, including 10 to 50 mass % of a vinyl ether group-containing (meth)acrylate represented by the following Formula 1: CH₂═CR¹—COOR²—O—CH═CH—R³ (where R¹ is a hydrogen atom or a methyl group, R² is a divalent organic residue having 2 to 20 carbon atoms, and R³ is a hydrogen atom or a monovalent organic residue having 1 to 11 carbon atoms.

3. The radiation curable ink composition according to aspect 1 or 2, wherein the nitrogen-containing monofunctional monomer includes an N-vinyl monomer.

4. The radiation curable ink composition according to any one of aspects 1 to 3, wherein the nitrogen-containing monofunctional monomer includes an amide acrylate.

5. The radiation curable ink composition according to any one of aspects 1 to 4, including an acylphosphine oxide-based polymerization initiator.

6. The radiation curable ink composition according to any one of aspects 1 to 5, including a hindered amine-based polymerization inhibitor.

7. The radiation curable ink composition according to any one of aspects 1 to 6, including a color material.

8. A recording method including discharging the radiation curable ink composition according to any one of aspects 1 to 7 by an ink jet system to adhere the ink composition to a non-absorbing recording medium and irradiating the adhered radiation curable ink composition with light.

### DESCRIPTION OF EXEMPLARY EMBODIMENTS

Embodiments of the present disclosure (hereinafter, referred to as “the embodiment”) will now be described in detail, but the present disclosure is not limited thereto and can be variously modified within a scope not changing the gist of the present disclosure. In the present specification, “(meth)acrylate” means at least one acrylate and its corresponding methacrylate.

Radiation Curable Ink Composition

The radiation curable ink composition of the embodiment (hereinafter, also simply referred to as “ink composition”) includes 5 to 30 mass % of a monofunctional urethane (meth)acrylate and 5 to 30 mass % of a nitrogen-containing monofunctional monomer having a cyclic skeleton containing a nitrogen atom and optionally includes, for example, another monomer, a polymerization initiator, a sensitizer, a polymerization inhibitor, a surfactant, a color material, and a dispersant.

Incidentally, the “radiation curable ink composition” is an ink composition that cures by irradiation with radiation, and examples thereof include an ultraviolet light curable ink composition and a photocurable ink composition. Examples of the radiation include ultraviolet light, infrared light, visible light, x-rays, and electron beams. In particular, ultraviolet light may be used from the viewpoint of ease of acquisition and effectiveness of a radiation source and ease of acquisition of a material.

Monofunctional Urethane (Meth)Acrylate

The monofunctional urethane (meth)acrylate may be any (meth)acrylic ester having a urethane bond, and examples thereof include a compound having one urethane bond and one polymerizable unsaturated double bond and represented by the following Formula 2. The use of such a monofunctional urethane (meth)acrylate tends to further improve the adhesion and the drawability of the resulting recorded matter. Such monofunctional urethane (meth)acrylates may be used alone or in combination of two or more thereof.

CH₂═CR⁴—COO—R⁵—OCONH—R⁶ 2

(where R⁴ is a hydrogen atom or a methyl group, R⁵ is an optionally substituted divalent hydrocarbon group, and R⁶ is an optionally substituted monovalent hydrocarbon group).

In the formula, the divalent hydrocarbon group represented by R⁵ is not particularly limited, and examples thereof include alkylene groups, such as a methylene group, an ethylene group, a propylene group, a butylene group, and a cyclohexylene group; arylene groups, such as a phenylene group and a naphthalene group; and aralkylene groups, such as a xylylene group. In particular, an alkylene group may be used, and a methylene group or an ethylene group, in particular, an ethylene group, can be used. The number of carbon atoms of the divalent hydrocarbon group represented by R⁵ may be 1 to 9, particularly, 1 to 6.

In the formula, the monovalent hydrocarbon group represented by R⁶ is not particularly limited, and examples thereof include an alkyl group, a cycloalkyl group, an alkenyl group, an aryl group, an alkyl aryl group, and an aryl alkyl group. In particular, an alkyl group may be used. The number of carbon atoms of the monovalent hydrocarbon group represented by R⁶ may be 1 to 9, particularly, 2 to 6.

The divalent hydrocarbon group represented by R⁵ and the monovalent hydrocarbon group represented by R⁶ may have a substituent. The substituent is not particularly limited, and examples thereof include a halogen atom, an alkyl group, an alkoxy group, a carbonyl group, an amino group, an imino group, a cyano group, an azo group, an azi group, a thiol group, a sulfo group, a nitro group, a hydroxy group, an acyl group, an aldehyde group, a cycloalkyl group, and aryl group.

The molecular weight of the monofunctional urethane (meth)acrylate may be 500 or less, in particular, 300 or less.

The monofunctional urethane (meth)acrylate is not particularly limited, and examples thereof include (methylcarbamoyloxy)ethyl (meth)acrylate, (ethylcarbamoyloxy)ethyl (meth)acrylate, (propylcarbamoyloxy)ethyl (meth)acrylate, (butylcarbamoyloxy)ethyl (meth)acrylate, (methylcarbamoyloxy)ethoxyethyl (meth)acrylate, (ethylcarbamoyloxy)ethoxyethyl (meth)acrylate, (propylcarbamoyloxy)ethoxyethyl (meth)acrylate, and (butylcarbamoyloxy)ethoxyethyl (meth)acrylate.

The content of the monofunctional urethane (meth)acrylate is 5 to 30 mass % based on the total amount of the ink composition and may be 10 to 25 mass %, in particular, 15 to 25 mass %. If the content of the monofunctional urethane (meth)acrylate is 5 mass % or more, the adhesion and the drawability of the resulting recorded matter tend to be further improved. In addition, if the content of the monofunctional urethane (meth)acrylate is 30 mass % or less, the viscosity of the ink composition can be suppressed, resulting in a tendency of further improvement in the storability. When the ink composition includes two or more monofunctional urethane (meth)acrylates, “the content” of the monofunctional urethane (meth)acrylate means the total content of the monofunctional urethane (meth)acrylates.

Nitrogen-Containing Monofunctional Monomer

The nitrogen-containing monofunctional monomer is a monofunctional monomer having a cyclic skeleton containing a nitrogen atom and having one polymerizable functional group. The nitrogen-containing monofunctional monomer is not particularly limited, and examples thereof include N-vinyl monomers, such as N-vinylcaprolactam, N-vinylcarbazole, and N-vinylpyrrolidone; and amide acrylates, such as acryloylmorpholine. In particular, an N-vinyl monomer or an amide acrylate may be used. The adhesion and the drawability of the resulting recorded matter tend to be further improved by using such a nitrogen-containing monofunctional monomer. Such nitrogen-containing monofunctional monomers may be used alone or in combination of two or more thereof.

The content of the nitrogen-containing monofunctional monomer is 5 to 30 mass % based on the total amount of the ink composition and may be 10 to 25 mass %, in particular, 15 to 25 mass %. If the content of the nitrogen-containing monofunctional monomer is 5 mass % or more, the adhesion and the drawability of the resulting recorded matter tend to be further improved. In addition, if the content of the nitrogen-containing monofunctional monomer is 30 mass % or less, the storability of the ink composition tends to be further improved. When the ink composition includes two or more nitrogen-containing monofunctional monomers, the “content” of the nitrogen-containing monofunctional monomer means the total content of the nitrogen-containing monofunctional monomers.

The total content of the monofunctional urethane (meth)acrylate and the nitrogen-containing monofunctional monomer may be 20 to 50 mass % based on the total amount of the ink composition and can be 25 to 45 mass %, in particular, 30 to 40 mass %. When the total content of the monofunctional urethane (meth)acrylate and the nitrogen-containing monofunctional monomer within the above range, the balance between the adhesion and the drawability of the resulting recorded matter and the storability of the ink composition tends to be further improved.

The content ratio of the nitrogen-containing monofunctional monomer to the monofunctional urethane (meth)acrylate may be 0.25 to 4 and can be 0.5 to 3, in particular, 0.75 to 1.5. When the content ratio of the nitrogen-containing monofunctional monomer to the monofunctional urethane (meth)acrylate is within the above range, the balance between the adhesion and the drawability of the resulting recorded matter and the storability of the ink composition tends to be further improved.

Another Monomer

The ink composition of the embodiment may include a monomer other than the monofunctional urethane (meth)acrylate and the nitrogen-containing monofunctional monomer described above. Such another monomer may be monofunctional or multifunctional and may be a single monomer or a mixture of two or more monomers.

The monofunctional monomer is not particularly limited, and examples thereof include aliphatic (meth)acrylates, such as stearyl (meth)acrylate and lauryl (meth)acrylate; aromatic (meth)acrylates, such as phenoxyethyl (meth)acrylate; alkylene glycol (meth)acrylates, such as butoxyethyl (meth)acrylate and ethoxydiethylene glycol (meth)acrylate; and hydroxy group-containing (meth)acrylates, such as 2-hydroxyethyl (meth)acrylate and 2-hydroxypropyl (meth)acrylate. In particular, phenoxyethyl (meth)acrylate may be used. By using such a monomer, the viscosity is decreased, and the storability tends to be further improved.

The content of the monofunctional monomer may be 2 to 30 mass % based on the total amount of the ink composition and can be 5 to 25 mass %, in particular, 10 to 20 mass %. When the content of the monofunctional monomer is within the above range, the viscosity is decreased, and the storability tends to be further improved.

The multifunctional monomer is not particularly limited, and examples thereof include vinyl ether group-containing (meth)acrylates, such as 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth) acrylate, 1-vinyloxymethylpropyl (meth)acrylate, 2-methyl-3-vinyloxypropyl (meth)acrylate, and 1,1-dimethyl-2-vinyloxyethyl (meth)acrylate; difunctional (meth)acrylates, such as diethylene glycol di(meth)acrylate, triethylene glycol di(meth)acrylate, and dipropylene glycol di(meth)acrylate; and trifunctional or higher multifunctional (meth)acrylates, such as trimethylolpropane tri(meth)acrylate and pentaerythritol tri(meth)acrylate. In particular, a vinyl ether group-containing (meth)acrylate or a difunctional (meth)acrylate may be used. By using such a monomer, the viscosity is decreased, and the curability tends to be further improved.

The vinyl ether group-containing (meth)acrylate may be any compound having a vinyl ether group and a (meth)acrylate group, and examples thereof include compounds represented by the following Formula 1:

CH₂═CR¹—COOR²—O—CH═CH—R³

(where R¹ is a hydrogen atom or a methyl group, R² is a divalent organic residue having 2 to 20 carbon atoms, and R³ is a hydrogen atom or a monovalent organic residue having 1 to 11 carbon atoms).

In the formula, the divalent organic residue having 2 to 20 carbon atoms represented by R² may be an optionally substituted linear, branched, or cyclic alkylene group having 2 to 20 carbon atoms, an optionally substituted alkylene group having 2 to 20 carbon atoms and having an oxygen atom of an ether bond and/or an ester bond in the structure, or an optionally substituted divalent aromatic group having 6 to 11 carbon atoms. In particular, an alkylene group having 2 to 6 carbon atoms, such as an ethylene group, an n-propylene group, an isopropylene group, and a butylene group, or an alkylene group having 2 to 9 carbon atoms and having an oxygen atom of an ether bond in the structure, such as an oxyethylene group, an oxy-n-propylene group, an oxyisopropylene group, and an oxybutylene group, may be used.

In the formula, the monovalent organic residue having 1 to 11 carbon atoms represented by R³ may be an optionally substituted linear, branched, or cyclic alkyl group having 1 to 10 carbon atoms or an optionally substituted aromatic group having 6 to 11 carbon atoms. In particular, an alkyl group having 1 or 2 carbon atoms, such as a methyl group and an ethyl group, or an aromatic group having 6 to 8 carbon atoms, such as a phenyl group and a benzyl group, may be used.

The content of the multifunctional monomer may be 10 to 70 mass % based on the total amount of the ink composition and can be 10 to 50 mass %, in particular, 15 to 40 mass %. When the content of the multifunctional monomer is within the above range, the viscosity is decreased, and the curability tends to be further improved.

Furthermore, especially, the content of the vinyl ether group-containing (meth)acrylate may be 10 to 50 mass % based on the total amount of the ink composition and can be 15 to 40 mass %, in particular, 15 to 30 mass %. If the content of the vinyl ether group-containing (meth)acrylate is 10 mass % or more, the viscosity is decreased, and the curability and the adhesion tend to be further improved. In addition, if the content of the vinyl ether group-containing (meth)acrylate is 50 mass % or less, the drawability tends to be further improved.

Polymerization Initiator

The polymerization initiator may be any initiator that generates active species by irradiation with radiation and initiates polymerization of the above-mentioned monomer. The polymerization initiator is not particularly limited, and examples thereof include aromatic ketones, acylphosphine oxide compounds, aromatic onium salt compounds, organic peroxides, thio compounds (such as thioxanthone compounds and thiophenyl group-containing compounds), α-aminoalkylphenone compounds, hexaaryl biimidazole compounds, ketoxime ester compounds, borate compounds, azinium compounds, metallocene compounds, active ester compounds, compounds having carbon-halogen bonds, and alkylamine compounds. Such polymerization initiators may be used alone or in combination of two or more thereof.

In particular, an acylphosphine oxide-based polymerization initiator, such as bis(2,4,6-trimethylbenzoyl)-phenylphosphine oxide (a commercial product is IRGACURE 819) and 2,4,6-trimethylbenzoyl-diphenylphosphine oxide (a commercial product is DAROCUR TPO), may be used. By using such a polymerization initiator, the curability and the storability tend to be further improved.

The content of the polymerization initiator may be 5 to 15 mass % based on the total amount of the ink composition and can be 7 to 13 mass %. When the content of the polymerization initiator is within the above range, the curability and the storability tend to be further improved. Sensitizer

The sensitizer is a colorless to weakly colored compound that can absorb light having a wavelength of about 300 to 450 nm, which is in the range of ultraviolet to short-wavelength visible light, and that can emit fluorescent light having a wavelength of about 400 to 500 nm. By including a sensitizer, the curability tends to be further improved.

Examples of the sensitizer include, but not limited to, thioxanthone compounds; naphthalene benzoxazoyl derivatives, such as 1,4-bis-(2-benzoxazoyl)naphthalene; thiophene benzoxazoyl derivatives, such as 2,5-thiophene diylbis(5-tert-butyl-1,3-benzoxazole); stilbene benzoxazoyl derivatives; coumarin derivatives; styrene biphenyl derivatives; pyrazolone derivatives; stilbene derivatives; styryl derivatives of benzene and biphenyl; bis(benzazol-2-yl) derivatives; carbostyryl, naphthalimido, and dibenzothiophene-5,5′-dioxide derivatives; pyrene derivatives; and pyridotriazole. In particular, Hostalux KCB (manufactured by Clariant GmbH) may be used. By using such a sensitizer, the dimensional accuracy and the curability tend to be further improved. Such sensitizers may be used alone or in combination of two or more thereof.

Polymerization Inhibitor

The polymerization inhibitor is not particularly limited, and examples thereof include hydroquinones represented by hydroquinone, hydroquinone monomethyl ether (MEHQ), 1-o-2,3,5-trimethylhydroquinone, and 2-tert-butylhydroquinone; catechols represented by catechol, 4-methylcatechol, and 4-tert-butylcatechol; phenols represented by phenol, butylhydroxytoluene, butylhydroxyanisole, p-methoxyphenol, cresol, pyrogallol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol); compounds having a 2,2,6,6-tetramethylpiperidine-N-oxyl skeleton represented by 4-hydroxy-2,2,6,6-tetramethylpiperidinyl-1-oxyl; and hindered amines represented by a compound having a 2,2,6,6-tetramethylpiperidine skeleton, a compound having a 2,2,6,6-tetramethylpiperidine-N-alkyl skeleton, and a compound having a 2,2,6,6-tetramethylpiperidine-N-acyl skeleton. Such polymerization inhibitors may be used alone or in combination of two or more thereof.

In particular, hydroquinones, such as hydroquinone monomethyl ether, or hindered amines, such as 4-hydroxy-2,2,6,6-tetramethylpiperidinyl-1-oxyl, may be used, and a hindered amine-based polymerization inhibitor can be especially used. By using such a polymerization inhibitor, the storability tends to be further improved.

The content of the polymerization inhibitor may be 0.10 to 0.50 mass % based on the total amount of the ink composition and can be 0.10 to 0.40 mass %, in particular, 0.10 to 0.30 mass %. When the content of the polymerization inhibitor is within the above range, the storability and the curability tend to be further improved.

Surfactant

The surfactant is not particularly limited, and examples thereof include silicone-based surfactants, fluorine-based surfactants, and acetylene glycol-based surfactants. In particular, a silicone-based surfactant may be used.

Examples of the silicone-based surfactant include polysiloxane compounds and polyether-modified organosiloxanes. Commercial products of the silicone-based surfactant are not particularly limited, and examples thereof include BYK-306, BYK-307, BYK-333, BYK-341, BYK-345, BYK-346, BYK-347, BYK-348, BYK-349, and BYK-UV3500 (trade names, manufactured by BYK Japan K.K.); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.).

The fluorine-based surfactant is not particularly limited, and examples thereof include perfluoroalkylsulfonates, perfluoroalkylcarboxylates, perfluoroalkylphosphates, perfluoroalkylethylene oxide adducts, perfluoroalkylbetaine, and perfluoroalkylamine oxide compounds. Commercial products of the fluorine-based surfactant are not particularly limited, and examples thereof include S-144 and S-145 (manufactured by AGC Inc.); FC-170C, FC-430, and Fluorad-FC4430 (manufactured by 3M Japan Limited); FSO, FSO-100, FSN, FSN-100, and FS-300 (manufactured by DuPont de Nemours, Inc.); and FT-250 and 251 (manufactured by NEOS Co., Ltd.). These fluorine-based surfactants may be used alone or in combination of two or more thereof.

The acetylene glycol-based surfactant is not particularly limited and may be, for example, at least one selected from 2,4,7,9-tetramethyl-5-decyne-4,7-diol and alkylene oxide adducts of 2,4,7,9-tetramethyl-5-decyne-4,7-diol and 2,4-dimethyl-5-decyne-4-ol and alkylene oxide adducts of 2,4-dimethyl-5-decyne-4-ol. Commercial products of the acetylene glycol-based surfactant are not particularly limited, and examples thereof include Olfine 104 series and E series such as Olfine E1010 (trade names, manufactured by Air Products Japan, Inc.) and Surfynol 465 and Surfynol 61 (trade names, manufactured by Nissin Chemical Industry Co., Ltd.). The acetylene glycol-based surfactants may be used alone or in combination of two or more thereof.

Color Material

The color material is not particularly limited, and examples thereof include carbon blacks (C.I. Pigment Black 7), such as Furnace Black, Lamp Black, Acetylene Black, and Channel Black; inorganic pigments, such as iron oxide and titanium oxide; and organic pigments, such as quinacridone pigments, quinacridone quinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments. The pigments may be used alone or in combination of two or more thereof.

The content of the color material may be 0.5 to 15 mass % based on the total amount of the ink composition and can be 1 to 10 mass %, in particular, 1 to 5 mass %.

Dispersant

By containing a dispersant, the dispersibility of the color material tends to be further improved. The dispersant is not particularly limited, and examples thereof include dispersants that are commonly used for preparing pigment dispersants, such as polymer dispersants, specifically, dispersants whose main component is at least one selected from polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. Examples of commercial products of the polymer dispersant include Ajisper series manufactured by Ajinomoto Fine-Techno Co., Ltd., Solsperse series (such as Solsperse 36000) manufactured by Lubrizol Corporation, DISPERBYK series manufactured by BYK-Chemie GmbH, and Dispalone series manufactured by Kusumoto Chemicals, Ltd.

The content of the dispersant may be 0.1 to 1 mass % based on the total amount of the ink composition and can be 0.1 to 0.5 mass %.

Recording Method

The recording method of the embodiment includes a step of discharging the radiation curable ink composition by an ink jet system to adhere the ink composition to a non-absorbing recording medium and a step of irradiating the adhered radiation curable ink composition with light.

Adhesion Step

The adhesion step is a step of adhering a radiation curable ink composition to a recording medium. The radiation curable ink composition is discharged using an ink jet head having, for example, an electromechanical transducer, such as a piezoelectric element that changes the volume of the cavity by mechanical deformation, or an electrothermal transducer that emits heat to generate bubbles in the ink and discharge the ink, resulting in adhesion of the ink composition to the recording medium.

The non-absorbing recording medium is not particularly limited, and examples thereof include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates produced by vapor deposition of various metals mentioned above, plastic films, and plates of alloys such as stainless steel and brass; and recording media prepared by bonding (coating) films of plastics such as polyvinyl chloride, polyethylene, polypropylene, polyethylene terephthalate (PET), polycarbonate, polystyrene, and polyurethane to base materials made of paper.

Curing Step

The curing step is a step of curing the radiation curable ink composition adhered to the recording medium by a radiation irradiation method. Ultraviolet light may be irradiated by any method. For example, an UV-LED light source can be used. By using an UV-LED light source, it is possible to decrease the size and prolong the lifetime of the recording apparatus and to increase the efficiency and decrease the cost of the recording method, compared to the case of using a metal halide light source or a mercury lamp.

### EXAMPLES

The present disclosure will now be more specifically described using examples and comparative examples. The present disclosure is not limited to the following examples.

Materials for Ink Composition

Main materials for the ink composition used in the following examples and comparative examples are as follows.

Monofunctional Urethane (Meth)Acrylate

2-(Butylcarbamoxyl)ethyl acrylate (Eternal Materials Co., Ltd., EM2080 (Oligomer 6101), abbreviated to “6101” in the table).

Nitrogen-Containing Monofunctional Monomer

n-Vinylcaprolactam (abbreviated to “nVC” in the table). Acryloylmorpholine (abbreviated to “ACMO” in the table).

Other Monomers

VEEA (2-(2-vinyloxyethoxy)ethyl acrylate, trade name, manufactured by Nippon Shokubai Co., Ltd., abbreviated to “VEEA” in the following table).

Biscoat #192 (phenoxyethyl acrylate, trade name, manufactured by Osaka Yuki Chemical Co., Ltd., abbreviated to “PEA” in the following table).

SR508 (dipropylene glycol diacrylate, trade name, manufactured by Sartomer, abbreviated to “DPGDA” in the following table).

Photoinitiator

Irgacure 819 (trade name, manufactured by BASF SE, acylphosphine oxide-based photoradical polymerization initiator, abbreviated to “819” in the table).

Speedcure TPO (trade name, manufactured by Lambson Ltd., acylphosphine oxide-based photoradical polymerization initiator, abbreviated to “TPO” in the table).

Sensitizer

Speedcure DETX (trade name, manufactured by Lambson Ltd., thioxanthone compound, abbreviated to “DETX” in the table).

Inhibitor

LA-7RD (2,2,6,6-tetramethyl-4-hydroxypiperidine-1-oxyl, trade name, manufactured by ADEKA Corporation, abbreviated to “LA-7RD” in the table).

MEHQ (p-methoxyphenol)

Surfactant

BYK-UV3500 (silicone-based surfactant, BYK Japan K.K., abbreviated to “BYK-UV3500” in the table).

Pigment

Pigment Blue 15:3

Dispersant

Solsperse 36000 (manufactured by LUBRIZOL Corporation, abbreviated to “solsperse36000” in the table).

Preparation of Ink Composition

Each material was mixed according to the compositions shown in the following Table 1 and thoroughly stirred to prepare each ink composition. In Table 1, the unit of numerical values is mass %, and the total is 100.0 mass %.

TABLE 1

| | | Example | | | | | | | | | | | | |
|---|---|---|---|---|---|---|---|---|---|---|---|---|---|---|
| Component | | 1 | 2 | 3 | 4 | 5 | 6 | 7 | 8 | 9 | 10 | 11 | 12 | 13 |
| Monofunctional urethane | 6101 | 20 | 20 | 20 | 30 | 5 | 20 | 20 | 20 | 20 | 20 | 20 | 10 | 20 |
| acrylate | | | | | | | | | | | | | | |
| Nitrogen-containing | nVC | 20 | | 10 | 20 | 20 | 30 | 5 | 15 | 2.5 | 20 | 20 | 10 | 20 |
| monofunctional monomer | ACMO | | 20 | 10 | | | | | 15 | 2.5 | | | | |
| Difunctional monomer | VEEA | 20 | 20 | 20 | 20 | 20 | 20 | 20 | 20 | 20 | 10 | | 52 | 20 |
| Monofunctional monomer | PEA | 14.6 | 14.6 | 14.6 | 4.6 | 29.6 | 4.6 | 29.6 | 4.6 | 29.6 | 14.6 | 14.6 | 2.6 | 14.7 |
| Difunctional monomer | DPGDA | 10 | 10 | 10 | 10 | 10 | 10 | 10 | 10 | 10 | 21 | 30 | 10 | 10 |
| Photoinitiator (radical) | 819 | 5.5 | 5.5 | 5.5 | 5.5 | 5.5 | 5.5 | 5.5 | 5.5 | 5.5 | 5.5 | 5.5 | 5.5 | 5.5 |
| | TPO | 4.5 | 4.5 | 4.5 | 4.5 | 4.5 | 4.5 | 4.5 | 4.5 | 4.5 | 4.5 | 4.5 | 4.5 | 4.5 |
| Sensitizer | DETX | 2.5 | 2.5 | 2.5 | 2.5 | 2.5 | 2.5 | 2.5 | 2.5 | 2.5 | 2.5 | 2.5 | 2.5 | 2.5 |
| Inhibitor | LA-7RD | 0.1 | 0.1 | 0.1 | 0.1 | 0.1 | 0.1 | 0.1 | 0.1 | 0.1 | 0.1 | 0.1 | 0.1 | |
| Inhibitor | MEHQ | 0.1 | 0.1 | 0.1 | 0.1 | 0.1 | 0.1 | 0.1 | 0.1 | 0.1 | 0.1 | 0.1 | 0.1 | 0.1 |
| Surfactant | BYK-UV3500 | 0.5 | 0.5 | 0.5 | 0.5 | 0.5 | 0.5 | 0.5 | 0.5 | 0.5 | 0.5 | 0.5 | 0.5 | 0.5 |
| Pigment | Pigment Blue 15:3 | 2 | 2 | 2 | 2 | 2 | 2 | 2 | 2 | 2 | 2 | 2 | 2 | 2 |
| Dispersant | solsperse36000 | 0.2 | 0.2 | 0.2 | 0.2 | 0.2 | 0.2 | 0.2 | 0.2 | 0.2 | 0.2 | 0.2 | 0.2 | 0.2 |
| Total | | 100 | 100 | 100 | 100 | 100 | 100 | 100 | 100 | 100 | 101 | 100 | 100 | 100 |
| Evaluation item | Viscosity | A | A | A | B | A | A | A | A | A | A | B | A | A |
| | Adhesion | A | A | A | A | B | A | B | A | B | A | A | A | A |
| | Drawability | A | A | A | A | B | A | B | A | B | A | A | B | A |
| | Storability | A | A | A | B | A | B | A | B | A | A | A | A | B |
| | Curability | A | A | A | A | A | A | A | A | A | B | B | A | A |

| | | Example | Comparative Example | | | | | | | | |
|---|---|---|---|---|---|---|---|---|---|---|---|
| Component | | 14 | 1 | 2 | 3 | 4 | 5 | 6 | 7 | 8 | 9 |
| Monofunctional urethane | 6101 | 20 | 31 | 51 | 4 | 20 | 20 | 20 | 20 | 20 | 20 |
| acrylate | | | | | | | | | | | |
| Nitrogen-containing | nVC | 20 | 20 | 6 | 20 | 31 | 4 | | | 16 | 2 |
| monofunctional monomer | ACMO | | | | | | | 31 | 4 | 15 | 2 |
| Difunctional monomer | VEEA | 20 | 20 | 20 | 20 | 20 | 20 | 20 | 20 | 20 | 20 |
| Monofunctional monomer | PEA | 18.8 | 3.6 | | 30.6 | 3.6 | 30.6 | 3.6 | 30.6 | 3.6 | 30.6 |
| Difunctional monomer | DPGDA | 10 | 10 | 7.6 | 10 | 10 | 10 | 10 | 10 | 10 | 10 |
| Photoinitiator (radical) | 819 | 5.5 | 5.5 | 5.5 | 5.5 | 5.5 | 5.5 | 5.5 | 5.5 | 5.5 | 5.5 |
| | TPO | 4.5 | 4.5 | 4.5 | 4.5 | 4.5 | 4.5 | 4.5 | 4.5 | 4.5 | 4.5 |
| Sensitizer | DETX | 0.5 | 2.5 | 2.5 | 2.5 | 2.5 | 2.5 | 2.5 | 2.5 | 2.5 | 2.5 |
| Inhibitor | LA-7RD | 0.1 | 0.1 | 0.1 | 0.1 | 0.1 | 0.1 | 0.1 | 0.1 | 0.1 | 0.1 |
| Inhibitor | MEHQ | 0.1 | 0.1 | 0.1 | 0.1 | 0.1 | 0.1 | 0.1 | 0.1 | 0.1 | 0.1 |
| Surfactant | BYK-UV3500 | 0.5 | 0.5 | 0.5 | 0.5 | 0.5 | 0.5 | 0.5 | 0.5 | 0.5 | 0.5 |
| Pigment | Pigment Blue 15:3 | | 2 | 2 | 2 | 2 | 2 | 2 | 2 | 2 | 2 |
| Dispersant | solsperse36000 | | 0.2 | 0.2 | 0.2 | 0.2 | 0.2 | 0.2 | 0.2 | 0.2 | 0.2 |
| Total | | 100 | 100 | 100 | 100 | 100 | 100 | 100 | 100 | 100 | 100 |
| Evaluation item | Viscosity | A | B | C | A | A | A | B | A | A | A |
| | Adhesion | A | A | A | C | A | C | A | C | A | C |
| | Drawability | A | A | A | B | A | B | A | B | A | B |
| | Storability | A | C | C | A | C | A | C | A | C | A |
| | Curability | A | A | A | A | A | A | A | A | A | A |

Viscosity

The viscosity at a temperature of 20° C. and a shear rate of 200 s⁻¹ was measured with a rheometer (Physica MCR-300, trade name, manufactured by Anton Paar GmbH). Evaluation criteria are as follows:

A: less than 20 mPa·s,

B: 20 mPa·s or more and less than 30 mPa·s, and

C: 30 mPa·s or more.

Adhesion

Radiation curable ink compositions were loaded into the corresponding nozzle arrays of an ink jet printer PX-G5000 (manufactured by Seiko Epson Corporation). A solid pattern image was printed on a PVC film (trade name “IJ180-10”, manufactured by 3M Company) under ordinary temperature and ordinary pressure such that the ink dot diameter was medium and the printed matter thickness was 10 μm and was cured by first irradiation at a wavelength of 385 nm and an irradiation intensity of 100 mW/cm² and then second irradiation at a wavelength of 395 nm and an irradiation intensity of 1000 mW/cm² by the UV-LED of an UV irradiation device mounted on the side of a carriage such that the integrated light intensity was 700 mJ/cm². As described above, a recorded matter in which a solid pattern image was printed on a PVC film was produced.

A single blade cutting tool (a commercially available cutter) as a cutting tool and a guide for performing cutting at equal intervals with the single blade cutting tool were prepared. Six cuts parallel to each other were made in each recorded matter by placing the blade of the cutting tool to be perpendicular to the cured film of the recorded matter. After making of the six cuts, the direction was changed by 90°, and six cuts were further made to be orthogonal to the already made cuts. Thus, cured films provided with cuts in a lattice pattern were prepared. Subsequently, transparent adhesive tape (width: 25±1 mm) with a length of about 75 mm was attached to the portion cut in a lattice pattern of the cured film and was sufficiently rubbed with a finger such that the cured film could be seen through the tape. Subsequently, within 5 minutes after the adhesion, the tape was reliably peeled off from the cured film at an angle of approximately 60° in 0.5 to 1.0 seconds. The adhesion was evaluated based on whether the presence or absence of peeling of the cured film from the recorded matter on this occasion by the following evaluation criteria:

A: peeling of the cured film was not observed or observed in 5% or less of the lattice,

B: peeling of the cured film was observed in more than 5% and 35% or less of the lattice, and

C: peeling of the cured film was observed in more than 35% of the lattice.

Drawability

The ink composition prepared as described above was applied onto a polyvinyl chloride film (JT5829R, manufactured by MACtac) at a thickness of 10 μm with a bar coater. Subsequently, the ink composition was cured with an energy of 400 mJ/cm² using a metal halide lamp (manufactured by Eye Graphics Co., Ltd.) to form a coating film. The release paper of the polyvinyl chloride film on which the coating film was formed was peeled off, and the polyvinyl chloride film was cut into a strip having a width of 1 cm and a length of 8 cm to produce a test piece. The elongation percentage of the test piece of each ink composition was measured as drawability using a tensile testing machine (TENSILON, manufactured by Orientec Corporation). The elongation percentage was the numerical value at the time when a crack occurred. The evaluation criteria are as follows:

A: 100% or more,

B: 30% or more and less than 100%, and

C: less than 30%.

Storability

The ink compositions prepared as in above were put in an airtight container and were left to stand under an environment of 60° C. for 4 weeks. The viscosity of each ink composition was measured before and after the standing with a HAAKE rheometer RS75. Subsequently, the rate of change in the viscosity of each ink composition was determined by the following expression:

Viscosity change rate=[(viscosity value after 4 weeks)/(initial viscosity value)×100]−100(%)

The evaluation criteria are as follows:

A: viscosity change rate of less than 2%,

B: viscosity change rate of 2% or more and less than 3%, and

C: viscosity change rate of 3% or more.

Curability

The ink composition prepared as described above was applied onto a PET film (PET50A PLSIN [trade name], manufactured by Lintec Corporation) with a bar coater. Subsequently, the coating film was cured through irradiation with ultraviolet light by an LED having a wavelength of 395 nm. The thickness of the resulting coating film was 8 μm (thickness after curing). The cured coating film (cured film) was rubbed with a swab while applying a load of 100 g 10 times, and the curing energy (irradiation energy) at the time of not getting scratched was determined. The irradiation energy [mJ/cm²] was determined by measuring the irradiation intensity [mW/cm²] at the surface irradiated with light from a light source and multiplying the intensity by the irradiation duration time [s]. The irradiation intensity was measured with an ultraviolet intensity meter UM-10 and a light receiver UM-400 (both manufactured by Konica Minolta Sensing, Inc.). Evaluation criteria are as follows:

A: 200 mJ/cm² or less,

B: higher than 200 mJ/cm² and 300 mJ/cm² or less, and

C: higher than 300 mJ/cm².

As shown by comparison of Examples and Comparative Examples, it is demonstrated that an ink composition including a predetermined amount of a monofunctional urethane (meth)acrylate and a predetermined amount of a nitrogen-containing monofunctional monomer having a cyclic skeleton containing a nitrogen atom has excellent storability and viscosity and can form a recorded matter with excellent adhesion. In particular, it was demonstrated that if the amount of the monofunctional urethane (meth)acrylate is higher than a predetermined level, the storability is decreased, and the viscosity is increased and that in contrast, if the amount of the monofunctional urethane (meth)acrylate is too small, the adhesion becomes poor. If the amount of the nitrogen-containing monofunctional monomer is too large, a decrease in the storability is observed, and if the amount is too small, a decrease in the adhesion is observed.

What is claimed is:

1. A radiation curable ink composition comprising:
5 to 30 mass % of a monofunctional urethane (meth) acrylate, and
5 to 30 mass % of a nitrogen-containing monofunctional monomer having a cyclic skeleton containing a nitrogen atom.

2. The radiation curable ink composition according to claim 1, comprising:
a vinyl ether group-containing (meth)acrylate represented by Formula 1:
CH₂═CR¹—COOR²—O—CH═CH—R³
(where R¹ is a hydrogen atom or a methyl group, R² is a divalent organic residue having 2 to 20 carbon atoms, and R³ is a hydrogen atom or a monovalent organic residue having 1 to 11 carbon atoms).

3. The radiation curable ink composition according to claim 2, comprising the vinyl ether group-containing (meth)acrylate in an amount of 10 to 50 mass %.

4. The radiation curable ink composition according to claim 1, wherein
the nitrogen-containing monofunctional monomer includes an N-vinyl monomer.

5. The radiation curable ink composition according claim 1, wherein
the nitrogen-containing monofunctional monomer includes an amide acrylate.

6. The radiation curable ink composition according to claim 1, comprising:
an acylphosphine oxide-based polymerization initiator.

7. The radiation curable ink composition according to claim 1, comprising:
a hindered amine-based polymerization inhibitor.

8. The radiation curable ink composition according to claim 1, comprising:
a color material.

9. A recording method comprising:
discharging the radiation curable ink composition according to claim 1 by an ink jet system to adhere the ink composition to a non-absorbing recording medium; and
irradiating the adhered radiation curable ink composition with light.
